(19) United States
(12) Patent Application Publication
(10) Pub. No.: US 2010/0294524 A1
(43) Pub. Date: Nov. 25, 2010

(54) AGRICULTURAL IMPLEMENTS

(76) Inventor: James Lawrenson, Lancashire (GB)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/095,624

(22) PCT Filed: Nov. 16, 2006
(86) PCT No.: PCT/GB06/04260

§ 371 Date: Aug. 6, 2010

(30) Foreign Application Priority Data
Dec. 1, 2005 (GB) 0524476.9

(51) Int. Cl. A01B 59/043; A01B 59/04; A01B 35/04

(52) U.S. Cl. 172/439; 172/678; 172/613

(57) ABSTRACT

A coupling (31, 32) for use with agricultural implements (1) such as yard scrapers, and agricultural implements including the coupling (31, 32) are described. The coupling (31, 32) sits between connection means (20) such as a vehicle mounting point, and a working portion (1) such as the frame (10) of a yard scraper (1). The coupling is simple, and provides an effective way for transferring load between the connection means (20) and the working portion (1).

### FIELD OF THE INVENTION

The present invention relates to agricultural implements, in particular to agricultural implements for use with a vehicle such as an agricultural tractor.

### BACKGROUND TO THE INVENTION

Agricultural implements, such as scraping apparatus for scraping surface deposits from a farmyard or the like during both forward and rearward movement of a tractor to which they are attached are known from e.g. GB 2 050 475.

The apparatus of GB 2 050 474 includes scraping blades with a resilient portion arranged to contact the surface to be scraped so as to provide a partial sealing contact between the blades and the surface to be scraped. This allows the scraping of liquids and slurries, as well as solids and semi-solids. The resilient portion of the blades can be conveniently formed from a plastics or rubber material.

When using the apparatus of GB 2 050 474 the height at which the apparatus is held above the surface to be scraped is important. Holding the apparatus nearer to the surface increases scraping pressure, and can lead to more effective scraping. However, excessive scraping pressure can lead to rapid wear of the scraping blades, in particular wear of resilient portions on the scraping blades. To address this problem, adjustable pivoting and spring loaded connection means for connection to a tractor have been developed. However, these means are relatively complex, and are therefore relatively expensive. Furthermore, regular adjustment by a user may be required to achieve optimum scraping without excessive wear.

Also, if the connection means does not align the apparatus parallel to the surface to be scraped, either through connection inaccuracy or unevenness in the surface to be scraped, uneven blade wear and/or ineffective scraping may occur.

Similar problems may occur in other agricultural implements such as ploughs, balers, mowers etc. where a connection means is joined to a working portion.

It is an aim of preferred embodiments of the present invention to address one problems associated with the prior art, whether identified herein, or otherwise.

### SUMMARY OF THE INVENTION

According to a first aspect of the present invention there is provided an agricultural implement comprising: a working portion; and a connection means adapted for connection to a vehicle, wherein the working portion is coupled to the connection means by a flexible coupling means.

Suitably, the flexible coupling means comprises a coupling strip.

Suitably, the agricultural implement comprises a yard scraper, and the working portion comprises a frame with a first scraping blade.

Suitably, the frame depends from the connection means supported by the coupling strip.

Suitably, the first scraping blade is effective in a scraping direction. Suitably, the coupling strip extends substantially perpendicular to the scraping direction.

Suitably, the yard scraper further comprises a stop means located adjacent to the coupling strip. Suitably, the stop means is arranged to limit movement of the frame relative to the connection means in a direction parallel to the scraping direction. Suitably, the stop means is arranged to limit movement of the frame relative to the connection means in a vertical direction.

Suitably, the stop means comprises a rigid flange extending from the connection means and/or the frame, the rigid flange located alongside the coupling strip. Suitably, displacement of the frame relative to the connection means in a direction parallel to the scraping direction causes the coupling strip to engage the rigid flange. Suitably, the rigid flange runs substantially parallel to the coupling strip.

Suitably, the stop means comprises a resilient flange extending from the connection means and/or the frame, the resilient flange located alongside the coupling strip. Suitably, displacement of the frame relative to the connection means in a direction parallel the scraping direction causes the resilient flange to engage the rigid flange. Suitably, the resilient flange runs substantially parallel to the coupling strip.

Suitably, the resilient flange is located on one of the frame and the connection means, and the rigid flange is located on the other of the frame and the connection means. Suitably, the resilient flange is located on the connection means. Suitably, the resilient flange and the rigid flange are located alongside the same side of the coupling strip.

Suitably, the coupling strip is a first coupling strip, and yard scraper comprises a second flexible coupling means in the form of a second coupling strip arranged spaced apart from the first coupling strip in the scraping direction. Suitably, the first and second coupling strips are of substantially identical construction. Suitably, the stop means is a first stop means comprising first rigid and resilient flanges associated with the first coupling strip, and the yard scraper comprises a second stop means associated with the second coupling strip and comprising second rigid and resilient flanges.

Suitably, the frame comprises a second scraping blade spaced apart from the first scraping blade in the scraping direction, each blade capable of pivoting towards the other. Suitably, the second blade is effective in a reverse scraping direction. Suitably, the first and second blades are substantially parallel to one another. Suitably, the reverse scraping direction is parallel to the scraping direction, but is of opposite sense to the first scraping direction.

Suitably, displacement of the connection means in the scraping direction relative to the frame moves the first coupling strip away from the first rigid flange and moves the second coupling strip toward the second rigid flange. Suitably, displacement of the connection means in the scraping direction relative to the frame moves the first resilient flange toward the first rigid flange, and moves the second resilient flange away from the second rigid flange. Suitably, displacement of the connection means in the reverse scraping direction relative to the frame has the opposite effects.

Suitably, the first and second stop means are of substantially identical construction, arranged to operate substantially symmetrically in response to relative displacement of the frame and the connection means in the scraping and reverse scraping directions.

Suitably, the or each coupling strip comprises a strip of resilient material. Suitably, the or each coupling strip comprises a rubber or plastics material.

Suitably, one or both of the blades has a resilient portion along a lower edge. Suitably, the resilient portion comprises a strip of rubber or resilient plastics material.

Suitably, the connection means is arranged to be connected to a three-point linkage of an agricultural tractor.

According to a second aspect of the present invention there is provided a kit of parts for incorporation with an agricultural implement comprising: a working portion; and a connection means adapted for connection to a vehicle, wherein the kit of parts comprises a flexible coupling means for coupling the working portion to the connection means.

Suitably, the flexible coupling means is as described in the first aspect of the invention above.

Suitably, the kit of parts further comprises a stop means for incorporation with the frame and/or the connection means. Suitably, the stop means is as described in the first aspect of the invention above.

Suitably, the kit further comprises fixings for retaining the flexible coupling means. Suitably, the kit further comprises fixings for retaining the stop means.

### BRIEF INTRODUCTION TO THE FIGURES

For a better understanding of the invention, and to show how embodiments of the same may be carried into effect, reference will now be made, by way of example, to the accompanying diagrammatic drawings in which:

FIG. 1 shows a side view of a yard scraper according to a first embodiment of the invention coupled to an agricultural tractor;

FIG. 2 shows a side perspective view of a second coupling strip;

FIG. 3 shows a side perspective view of a first coupling strip;

FIG. 4 shows a side view of a yard scraper according to a second embodiment of the invention;

FIG. 5 shows a side view of a yard scraper according to a third embodiment of the invention;

FIG. 6 shows a side view of a yard scraper according to a fourth embodiment of the invention; and

FIG. 7 shows a side vies of a yard scraper according to a fifth embodiment of the invention.

### DESCRIPTION OF PREFERRED EMBODIMENTS

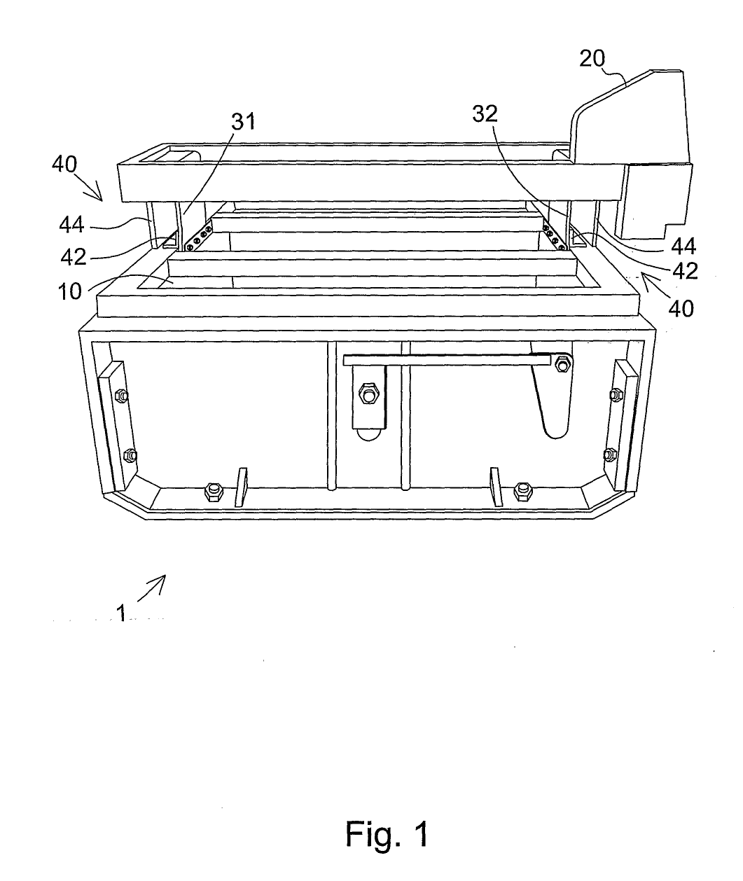

Referring now to FIG. 1 of the drawings, in a first embodiment of the invention an agricultural implement in the form of a yard scraper 1 comprises working portion comprising a frame 10, the frame coupled to a connection means 20. The connection means 20 is shown connected to an agricultural tractor. The yard scraper 1 can be pulled or pushed by a vehicle coupled to the connection means, and operates in a scraping direction left to right as seen in FIG. 1, and a reverse scraping direction right to left as seen in FIG. 1.

The frame 10 and connection means 20 are coupled to one another by a flexible coupling means in the form of first and second coupling strips 31,32. The first and second coupling strips 31,32 are arranged substantially perpendicular to the scraping and reverse scraping directions. The coupling strips 31,32 comprise a resilient, rubber material. Each coupling strip also has a stop means 40 associate therewith.

In use the connection means 20 is held by a vehicle so that the frame 10 depends from the connection means 20. The frame 10 comprises a base 12. In use the connection means 20 is held by a vehicle so that the base 12 is in contact with the surface to be scraped. Within the frame, first and second scraping blades are provided to engage the surface to be scraped and to perform the scraping. The first scraping blade is provided relatively further away from the tractor as shown in FIG. 1, and the second scraping blade is provided relatively closer to the tractor as shown in FIG. 1. The first and second scraping blades are pivotally coupled to the frame 12, and can pivot towards one another.

Any slight inaccuracy in the alignment of the connection means 20, or unevenness in the surface to be scraped are automatically compensated for by the natural flexibility and stretch of the coupling strips 31,32. Furthermore, excess scraping pressure can be avoided, as the coupling strips 31,32 compress and buckle if the frame 10 is forced too close to the connection means 20. These factors combine allow a large tolerance in the positioning of the connection means 20 over which effective scraping can be achieved.

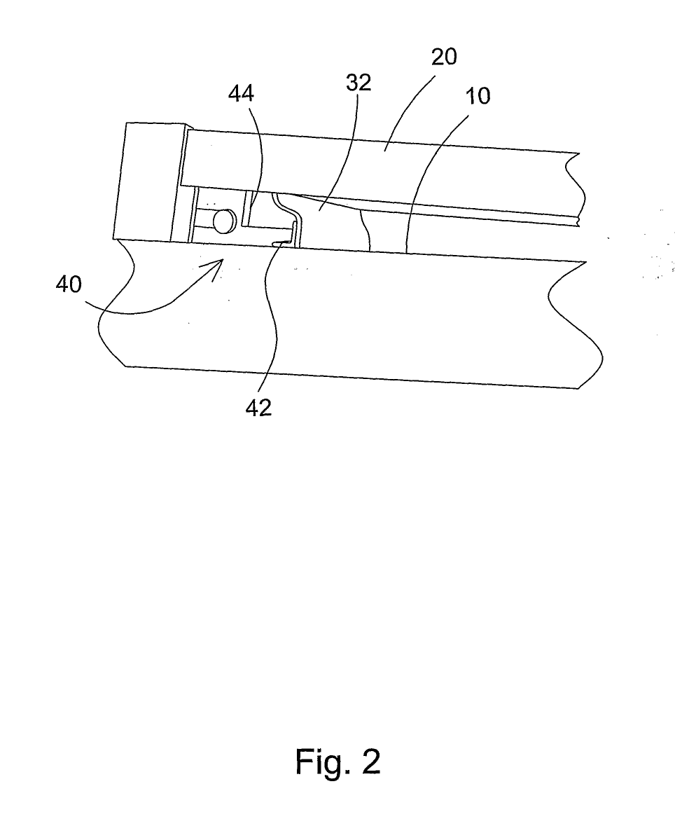

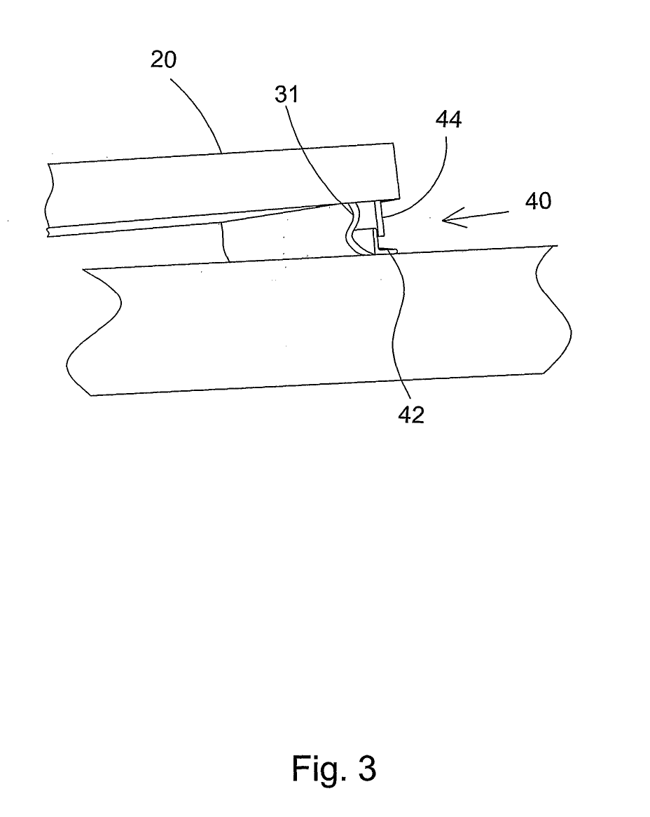

The operation of the first and second coupling strips 31,32 and the stop means 40 will now be described with reference to FIGS. 2 and 3.

The first coupling strip 31 has a stop means 40 adjacent to it, with the stop means 40 arranged to limit movement of the frame 10 relative to the connection means 20. The stop means 40 comprises a rigid flange 42 which is involved in limiting relative movement between the frame 10 and the connection means 20 parallel to the scraping direction, and further comprises a resilient flange 44 which is involved in limiting the approach of the connection means 20 to the frame 10, and also involved in limiting relative movement between the frame 10 and the connection means 20 parallel to the scraping direction.

The rigid flange 42 extends from the frame 10 and runs alongside and parallel to the coupling strip 31. Displacement of the frame 10 in the reverse scraping direction relative to the connection means, 20 causes the first coupling strip 31 to engage the rigid flange 42. Engagement of the first coupling strip 31 with the rigid flange is shown in FIG. 2.

The resilient flange 44 extends from the connection means 20, and runs alongside and parallel to the coupling strip 31. Displacement of the frame 10 relative to the connection means 20 in the scraping direction causes the coupling strip to engage the rigid flange 42. The resilient flange 44 and the rigid flange 42 are located alongside the same side of the coupling strip 31 as one another. The resilient flange 44 can deform to allow some flexibility to the coupling between the frame 10 and the connection means 20 even when loading on the frame 10 causes relative displacement such that the rigid and resilient flanges 42,44 contact one another.

The resilient flange 44 may also engage the frame 20 to prevent vertical bumping of the frame 10 against the connection means 20.

The second coupling strip 32 also has a stop means 40 adjacent to it, with the stop means 40 arranged to limit movement of the frame 10 relative to the connection means 20 in conjunction with the stop means 40 adjacent to the first coupling strip 31.

As can be seen from FIG. 1, the coupling strips 31,32 and stop means 40 are generally symmetrical about a vertical reflection plane at the middle of the yard scraper 1 when viewed from the side. The operation of the stop means 40 located adjacent to the second coupling strip 32 will be not be described—it is clear that with the directions reversed the stop means both function in substantially the same way. Both first and second coupling strips 31,32 and stop means 40 cooperate to maintain the relative position of the frame 10 and the coupling means 20 when the yard scraper 1 is in use.

In particularly preferred embodiment the connection means 20 is arranged to be connected to a three-point linkage of an agricultural tractor. However, the connection means 20 may have any suitable interface for coupling to a vehicle or other source of motive power.

Coupling strips and resilient flanges of approximately 1-2 cm thick rubber are preferred for yard scrapers of around 2 m width. However, the material type and thickness chosen can be varied according to the weight, dimensions and expected scraping loads of a particular yard scraper. As well as natural and synthetic rubbers, a range of plastics materials can be used.

In particularly preferred embodiments the second coupling strip 32 may be made thinner than the first coupling strip 31, or otherwise made more flexible. Typically, the loads imposed on the first coupling strip 31 in use are less than the loads imposed on the second coupling strip 32.

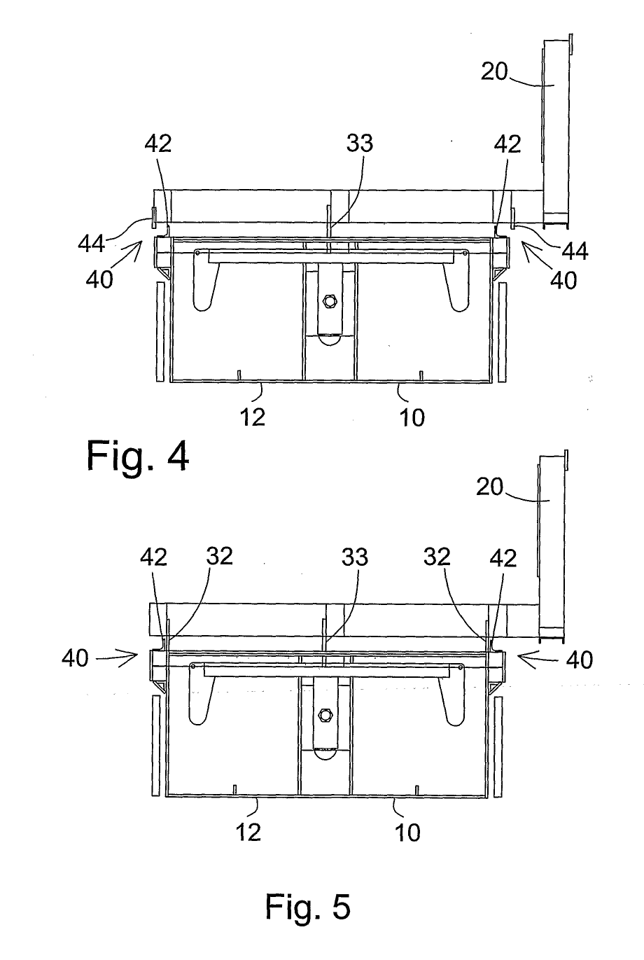

FIGS. 4-7 show alternative coupling strips. In FIG. 4, a centrally positioned coupling strip 33 is provided, with stop means 40 as in the embodiment of FIGS. 1-3. In FIG. 5 the centrally positioned coupling strip 33 is used with simplified stop means 40. The simplified stop means do not include the resilient flanges 44.

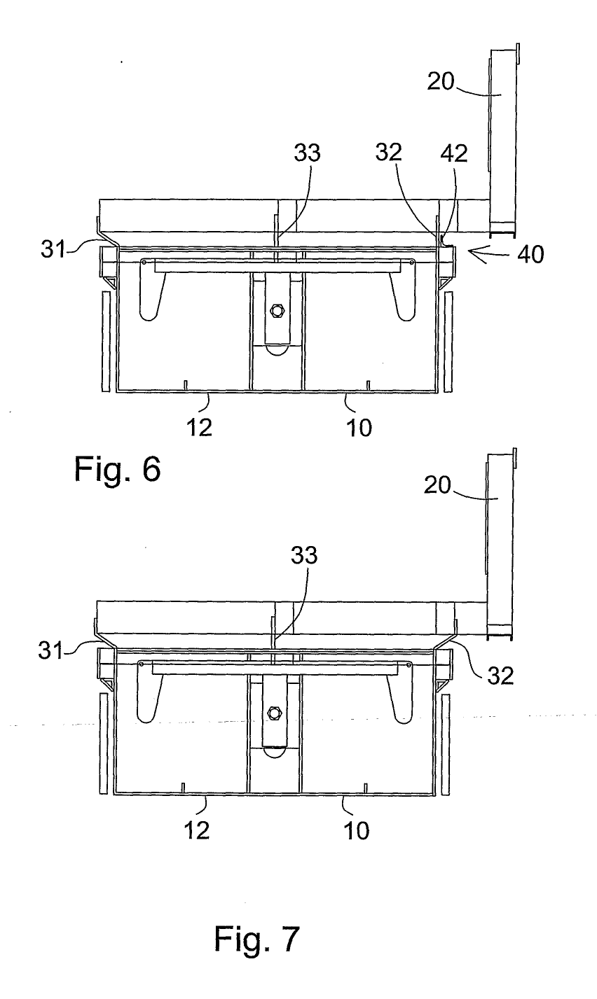

FIG. 6 shows an embodiment in which a central coupling strip 33 is provided; a simplified stop means 40 is provided for the second coupling strip, and the first coupling strip is at rest in a non-planar configuration, with upper and lower edges offset from one another.

FIG. 7 shows an embodiment in which first and second coupling strips 31,32 are arranged at rest in a non-planar configuration, with upper and lower edges offset from one another.

Although single continuous coupling strips have been described, it will be appreciated that other arrangements are possible, for example discontinuous strips, or two or more close coupled or spaced apart parallel strips could be used. Preferably, the coupling strips are retained by clamping in place, sandwiched between a cross member in the frame and a support plate bolted through the coupling strip and the cross member. In addition or as an alternative to the two coupling strips, a single coupling strip aligned centrally to the frame could be used.

In other embodiments, the coupling strips may be connected to the frame/connection means in such a way as to allow the position or rotation of the coupling strips to be adjusted. Such adjustment can be used to vary the load bearing characteristics of the coupling strips. The relative separation of the frame and connection means may also be altered this way, either by fixing in one of a plurality of predetermined settings or by powered on the fly adjustment.

The coupling strips described exhibit desirable characteristics when the yard scraper is accelerated, from rest, and when the yard scraper is in use scraping a surface. As the yard scraper is accelerated from rest the coupling strips are deflected, producing an upward force on the frame due to tension in the coupling strips. The upward force on the frame reduces the contact force with the surface to be scraped, and therefore reduces the frictional force between the frame and the surface to be scraped. Reducing the frictional force on acceleration reduces the demand on the vehicle drawing the yard scraper.

Furthermore, when the yard scraper described is in use scraping a surface the coupling strips are deformed by the weight and drag of the frame. The coupling strips can deform by twisting, buckling and compressing to absorb and/or deflect any accidental impacts between the frame 10 and e.g. a projecting wall or other obstacle. In the unlikely event of damage to a coupling strip, it is relatively easy to replace the coupling strip using simple tools. It is preferable that impact damage is restricted to the relatively inexpensive coupling strips, rather than to the metal components of the frame or connection means. This is so that repair of the yard scraper can be effected easily and cheaply.

Thus a yard scraper has been described which is of simple construction, and which offers effective scraping without the need for complicated user adjustments. The yard scraper described also reduces blade wear, is effectively self levelling and has a benefits in resilience to cope with accidental knocks. Although the example of a yard scraper has been used, other embodiments may comprise, agricultural implements such as ploughs, balers, mowers etc.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An agricultural implement comprising: a working portion; and a connection means adapted for connection to a vehicle, wherein the working portion is coupled to the connection means by a flexible coupling means.

2. The agricultural implement of claim 1, wherein the flexible coupling means comprises a coupling strip.

3. The agricultural implement of claim 2, wherein the agricultural implement is a yard scraper and the working portion comprises a frame with a first scraping blade effective in a scraping direction.

4. The agricultural implement of claim 3, wherein the frame depends from the connection means supported by the coupling strip.

5. The agricultural implement of claim 3, wherein the first scraping blade is effective in a scraping direction and wherein the coupling strip extends substantially perpendicular to the scraping direction.

6. The agricultural implement of claim 5, further comprising a stop means located adjacent to the coupling strip.

7. The agricultural implement of claim 6, wherein the stop means is arranged to limit movement of the frame relative to the connection means in a direction parallel to the scraping direction.

8. The agricultural implement of claim 6, wherein the stop means is arranged to limit movement of the frame relative to the connection means in a vertical direction.

9. The agricultural implement of claim 6, wherein the stop means comprises a rigid flange extending from the connection means and/or the frame, the rigid flange located alongside the coupling strip.

10. The agricultural implement of claim 9, wherein displacement of the frame relative to the connection means in a direction parallel to the scraping direction causes the coupling strip to engage the rigid flange.

11. The agricultural implement of claim 9, wherein the rigid flange runs substantially parallel to the coupling strip.

12. The agricultural implement of claim 6, wherein the stop means comprises a resilient flange extending from the connection means and/or the frame, the resilient flange located alongside the coupling strip.

13. The agricultural implement of claim 12, wherein displacement of the frame relative to the connection means in a direction parallel the scraping direction causes the coupling strip to engage the rigid flange.

14. The agricultural implement of claim 12, wherein the resilient flange runs substantially parallel to the coupling strip.

15. The agricultural implement of claim 12, wherein the resilient flange is located on one of the frame and the connection means, and the rigid flange is located on the other of the frame and the connection means.

16. The agricultural implement of claim 15, wherein the resilient flange is located on the connection means.

17. The agricultural implement of claim 12, wherein the resilient flange and the rigid flange are located alongside the same side of the coupling strip.

18. The agricultural implement of claim 2, wherein the coupling strip is a first coupling strip, and agricultural implement comprises a second flexible coupling means in the form of a second coupling strip arranged spaced apart from the first coupling strip.

19. The agricultural implement of claim 18, wherein the first and second coupling strips are arranged spaced apart in the scraping direction.

20. The agricultural implement of claim 18, wherein the first and second coupling strips are of substantially identical construction.

21. The agricultural implement of claim 18, wherein the stop means is a first stop means comprising first rigid and resilient flanges associated with the first coupling strip, and the yard scraper comprises a second stop means associated with the second coupling strip and comprising second rigid and resilient flanges.

22. The agricultural implement of claim 3, wherein the frame comprises a second scraping blade spaced apart from the first scraping blade in the scraping direction, each blade capable of pivoting towards the other.

23. The agricultural implement of claim 22, wherein the second blade is effective in a reverse scraping direction.

24. The agricultural implement of claim 23, wherein the reverse scraping direction is parallel to the scraping direction, but is of opposite sense to the first scraping direction.

25. The agricultural implement of claim 22, wherein the first and second blades are substantially parallel to one another.

26. The agricultural implement of claim 21, wherein displacement of the connection means in the scraping direction relative to the frame moves the first coupling strip away from the first rigid flange and moves the second coupling strip toward the second rigid flange.

27. The agricultural implement of claim 26, wherein displacement of the connection means in the scraping direction relative to the frame moves the first resilient flange toward the first rigid flange, and moves the second resilient flange away from the second rigid flange.

28. The agricultural implement of claim 26, wherein displacement of the connection means in the reverse scraping direction relative to the frame has the opposite effects.

29. The agricultural implement of claim 21, wherein the first and second stop means are of substantially identical construction, arranged to operate substantially symmetrically in response to relative displacement of the frame and the connection means in the scraping and reverse scraping directions.

30. The agricultural implement of claim 18, wherein the or each coupling strip comprises a strip of resilient material.

31. The agricultural implement of claim 18, wherein the or each coupling strip comprises a rubber or plastics material.

32. The agricultural implement of claim 22, wherein one or both of the scraping blades has a resilient portion along a lower edge.

33. The agricultural implement of claim 1, wherein the connection means is arranged to be connected to a three-point linkage of an agricultural tractor.

34. A kit of parts for incorporation with an agricultural implement comprising: a working portion; and a connection means adapted for connection to a vehicle, wherein the kit of parts comprises a flexible coupling means for coupling the working portion to the connection means.

35. The kit of claim 34, wherein the flexible coupling means comprises a flexible coupling strip.

36. The kit of claim 34, further comprising a frame and a stop means for incorporation with the frame and/or the connection means.

37. The kit of claim 36, wherein the stop means comprises a rigid flange extending from the connection means and/or the frame and the stop means functions to limit movement of the frame relative to the connection means in a direction parallel to a scraping direction or to limit movement of the frame relative to the connection means in a vertical direction.

38. The kit of claim 37, further comprising fixings for retaining the stop means.

39. The kit of claim 34 further comprising fixings for retaining the flexible coupling means.

40. (canceled)
